(19) United States
(12) Patent Application Publication
(10) Pub. No.: US 2002/0163683 A1
(43) Pub. Date: Nov. 7, 2002

(54) Performance optimizer for transmission systems

(76) Inventors: Neophytos A. Antoniades, Leonia, NJ (US); Valeria L. da Silva, Hillsborough, NJ (US); Michael J. Yadlowsky, Corning, NY (US)

Correspondence Address: Susan Morse, Suite 150, 12200 Sunrise Valley Drive, Reston, VA, 20191, US

(21) Appl. No.: 09/817,629

(22) Filed: Mar. 26, 2001

(51) Int. Cl. H04B 10/08; H04J 14/02

(52) U.S. Cl. 359/110; 359/124

(57) ABSTRACT

Performance of a transmission system is optimized by compensating for both noise and fiber non-linearities in the transmission system. The transmission system between a transmission terminal and a reception terminal has at least two channels. A processor determines an adjustment for equalizing the predetermined characteristic for each channel, and then reduces the adjustment by a predetermined amount. A plurality of controllers, each associated with a transmitter in the transmission terminal, each receives the reduced adjustment for an associated channel and providing the reduced adjustment to an output of an associated transmitter. The determination of the adjustment may be made using measurements of received signals or may be estimated knowing the characteristics of the amplifiers in the system.

### BACKGROUND OF THE INVENTION

1. Field of the Invention

The present invention is directed to optimizing performance of a transmission system exhibiting fiber non-linearities, more particularly to optimizing performance of wavelength division multiplexed transmission systems.

2. Description of Related Art

Wavelength division multiplexing (WDM) is a technique employed for increasing the information conveying capacity in optical transmission networks. WDM systems transmit a plurality of different wavelengths, each wavelength corresponding to a different channel. A typical WDM system includes a plurality of N optical transmitters at differing wavelengths for a corresponding channel, a multiplexer combining the channels onto a single fiber, a demultiplexer separating the combined signal from the fiber into a plurality of channels, and a corresponding plurality of N receivers, each detecting the signal from the corresponding channel. Since the signal is attenuated over distance, the transmission path between the multiplexer and demultiplexer typically includes amplifiers that maintain the signal along the transmission path. These amplifiers are typically optical rather than electrical.

A major problem in implementing WDM systems is the presence of wavelength dependent gain profiles, loss profiles, noise profiles and saturation characteristics of the optical amplifiers and other components in the system. The wavelength dependent nature of these components result in the optical signal to noise ratio (OSNR) values at the receivers being unequal for equal transmitter optical power levels. In other words, each channel in the WDM system will encounter a different optical gain or loss, which can result in unacceptable performance and a large required dynamic range on the receiver.

In U.S. Pat. No. 5,225,922 to Chraplyvy et al., a technique disclosed for equalizing channel performance in point-to-point WDM systems uses the optical power level of each channel transmitter and the OSNR measured at each channel receiver. The channel transmitters are set to transmitter optical power levels calculated from the optical power level and the OSNR values at the receivers. This process is repeated until the difference between the channel OSNR values is within a desired range. While this technique can equalize the OSNR at the receivers after a few iterations, it requires expensive instruments such as an optical spectrum analyzer to measure the OSNR values. Further, this technique is not adaptable to more complex network configurations, i.e., other than point-to-point configurations.

A more flexible technique is set forth in U.S. Pat. No. 6,040,933 to Khaleghi et al., in which the performance of the channels is estimated from optical power measurements taken at the inputs of the optical amplifiers. This estimation is then used to adjust the optical power of the transmitters to equalize performance across the channels. Thus, this technique is adaptable to many configurations since it obtains information along the path, rather that at the end. This technique also eliminates the requirement for expensive exact measurement of the OSNR values.

However, none of the above techniques account for the fiber non-linearities that may be present in the optical path. The non-uniform gain profile of the amplifiers increases the fiber non-linearity penalties for the high gain channels whereas the performance of the lower gain channels is mostly affected by amplifier noise, as well as receiver electrical noise. Thus, the compensation based on OSNR or power equalization fails to optimize the performance of such systems.

### SUMMARY OF THE INVENTION

The present invention is therefore directed to an optimizer that overcomes one or more of the disadvantages of the related art.

It is an object of the present invention to optimize performance of a transmission system, in particular by compensating for both noise and fiber non-linearities in the transmission system.

The above and other objects may be realized by providing an optimizer for a transmission system between a transmission terminal and a reception terminal having at least two channels. The processor determines an adjustment for equalizing the predetermined characteristic for each channel, and then reduces the adjustment by a predetermined amount. The optimizer also includes a plurality of controllers, each associated with a transmitter in the transmission terminal. Each controller receives the reduced adjustment for an associated channel and providing the reduced adjustment to an output of an associated transmitter.

According to one aspect of the present invention, the optimizer includes a processor receiving detected signals of a predetermined characteristic for each channel from the reception terminal. The optimizer may include a wavelength selective switch at at least one location in the transmission system.

In accordance with another aspect of the present invention, the processor determines an adjustment to the in accordance with fiber non-linearities of the system and supplies the adjustment to a plurality of controllers, each controller associated with a transmitter in the transmission terminal. Each controller provides the adjustment to an output of an associated transmitter.

The above and other objects may be realized by providing a method of optimizing performance of a transmission system between a transmission terminal and a reception terminal having at least two channels. The method includes receiving detected signals of a predetermined characteristic for each channel, determining an adjustment for equalizing the predetermined characteristic for each channel, reducing the adjustment by a predetermined amount, and controlling an output of each transmitter in the transmission terminal in accordance with the reduced adjustment for an associated channel.

The determining the predetermined amount may include analyzing a profile of the quality of the signal and/or analyzing a relative influence of noise and fiber non-linearities in the system. The receiving may be from the reception terminal and/or a non-terminal point in the transmission system.

According to another aspect of the present invention, the determining an adjustment in accordance with fiber non-linearities of the system and controlling an output of each transmitter in the transmission terminal in accordance with the adjustment for an associated channel. The determining may be in accordance with both the fiber non-linearities of the system and noise, with a profile of the quality of the signal and/or with a relative influence of noise and fiber non-linearities in the system.

While the present invention is described herein with reference to illustrative embodiments for particular applications, it should be understood that the present invention is not limited thereto. Those having ordinary skill in the art and access to the teachings provided herein will recognize additional modifications, applications, and embodiments within the scope thereof and additional fields in which the invention would be of significant utility without undue experimentation.

### BRIEF DESCRIPTION OF THE DRAWINGS

The foregoing and other objects, aspects and advantages will be described with reference to the drawings, in which:

FIG. 1 is a schematic illustration of a transmission system with pre-emphasis control in accordance with the present invention;

FIG. 2 is a plot of performance indicated as Q versus wavelength for different corrections of the transmitters; and

FIG. 3 is a schematic illustration of a transmission system with pre-emphasis control including intermediate monitoring in accordance with the present invention.

### DETAILED DESCRIPTION OF THE ILLUSTRATIVE EMBODIMENTS

One way of estimating bit error rate (BER), and in turn the quality Q of the system, is to degrade the system performance by moving the decision threshold. Q is impacted by the noise from the optical amplifiers, the electrical noise at the receivers, the nonlinear effects in transmission fibers, and other noise and signal beating terms at the receiver. The fiber nonlinear effects that significantly impact WDM systems are four wave mixing (FWM) and cross-phase modulation (XPM). Since both of these fiber non-linear processes scale as the fourth power of the optical power, Q can be represented as

$$Q = \frac{{P}_{0}}{\sqrt{{aP}_{0} + {bP}_{0}^{4}}} \qquad ( 1 )$$

Where a=NhvGFBₑ, where N is the number of amplifiers of gain G equal to the span loss L and noise figure F, h is Planck's constant, v is the wave number of the light, and Bₑ is the receiver electrical bandwidth; P is the average output power per channel; and b is determined numerically, as set forth, for example, V. L. da Silva, et al. “Capacity Upgrade for Non-zero Dispersion-Shifted Fiber Based Systems”, National Fiber Optics Engineers Conference, September, 1999, hereby incorporated by reference in its entirety for all purposes. For noise limited systems, the “a” term dominates the Q. For fiber non-linear dominated systems, the “b” term dominates the Q. In other words, from equation (1), if the system is fiber non-linearity limited, then

Q∝1/P₀ (2)

while if the system is OSNR limited, then

Q∝\sqrt{P₀} (3)

From the proportional relationships set forth in equations (2) and (3) it is evident that the compensation for these different system features requires different approaches.

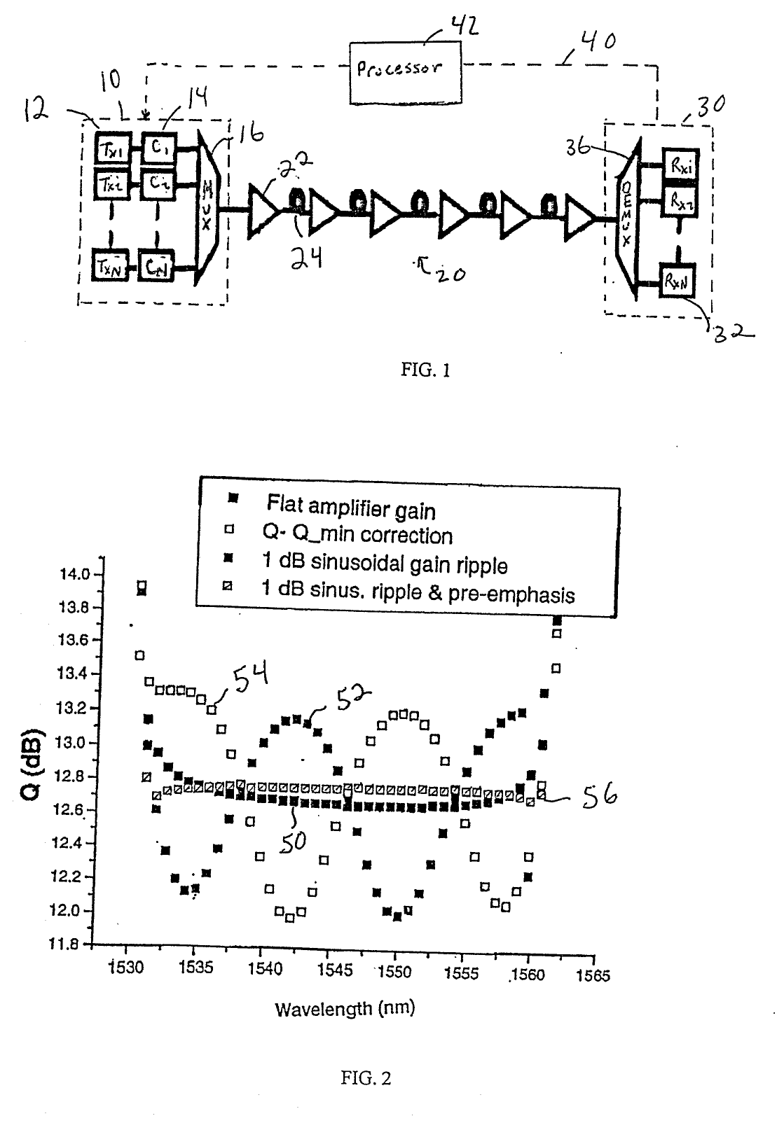

A schematic of the optimizer of the present invention is shown in FIG. 1. A transmitting terminal 10 includes a plurality of N transmitters 12, a corresponding plurality of controllers 14, and a multiplexer 16. Alternatively, the controllers 14 may be integral with the transmitters, e.g., altering the drive current of the transmitter. A receiving terminal 30 includes a demultiplexer 36 and a plurality of N receivers 32. A transmission system 20 between the transmitting terminal 10 and the receiving terminal 30 includes at least two optical amplifiers 22 and an optical fiber 24. The optical amplifiers 22 are provided as required between fiber spans. In the particular example shown in FIG. 1, the transmission system includes five spans of fiber and six optical amplifiers. Illustratively, the optical amplifiers are erbium doped fiber amplifiers (EDFA) or Raman amplifiers. The fibers may be non-zero dispersion shifted fiber (NZ-DSF).

A telemetry link 40 is provided between the receivers 32 and controllers 14 associated with each of the transmitters 12. The controllers 14 are any devices that can be used to selectively increase or decrease the power of the optical signal associated with the transmitter, e.g., a variable optical attenuator (VOA). The telemetry link 40 includes a processor 42, e.g., a microprocessor, which receives an output from each receiver and supplies each controller 14 with an appropriate control signal to control the power of each channel and an appropriate signal protocol. In accordance with the present invention, this control is realized by balancing the effects of fiber non-linearities and noise as set forth below.

Due to the fiber non-linearities, and as can be seen from equations (1)-(3) above, equalizing optical powers or OSNR does not necessarily optimize system performance. In a fiber non-linearity limited system, the OSNR equalization will simply invert the Q-curve with respect to the flat amplifier gain case. This can be seen in FIG. 2, in which curve 50 is the ideal flat amplifier gain, curve 52 is the true sinusoidal gain ripple of the system, and curve 54 is the OSNR equalized output. This inversion results from the operation of the OSNR equalization, which reduces the launched powers for the strong channels and increases the launched power for the weak channels. The higher power channels are influenced the most by XPM and the lower power channels are influenced the least. The low power channels are more influenced by the ASE noise and electrical noise at the receiver. In the OSNR equalization, the XPM is not taken into account. Since XPM is dependent on the power of the signals, applying the full pre-emphasis of the OSNR equalization, the shape of the O curve will be inverted.

By balancing the effects of noise and fiber non-linearities, the optimization of the present invention significantly approximates the ideal flat amplifier gain curve. The Q-curve of the optimization of the present invention is shown as curve 56 in FIG. 2. In the particular system shown by the curve 52 of FIG. 2, the optimization of the present invention is achieved by pre-emphasis using half the launched powers obtained from an OSNR equalization pre-emphasis algorithm, such as that noted in the techniques set forth above in the Background. As can be seen by curve 56 in FIG. 2, the performance of the worst channels, which are limiting the overall system performance, are significantly improved.

The performance of the system shown in curve 56 in FIG. 2 is optimized by the use of half the OSNR equalization evidently due to the shape of the ripple that causes the non-linearities of the system, here sinusoidal. While individual channels may display better performance for different ratios, the overall performance of the system, here within 0.2 dB of the ideal flat gain profile, is optimized by applying half the OSNR equalization. Presently, for other ripple shapes, such as a cosinusoidal ripple, half the equalization power is still optimal. Further, different systems with different contributions from noise and fiber non-linearities may require different multipliers.

The present solution uses information telemetry to set the appropriate power at the transmitters. Thus, the technique of the present invention can be implemented from the initial operation of the system, with no new equipment, upgrades or adjustments are needed at intermediate points in the system. In other words, details regarding intermediate loss, gain, amplifier types, and other intermediate elements are not needed. The optimization of the present invention currently provides satisfactory performance over eight spans of conventional optical fiber. The span point at which the optimizer will need to be re-implented of course depends upon the performance of the fiber and the requirements on the system.

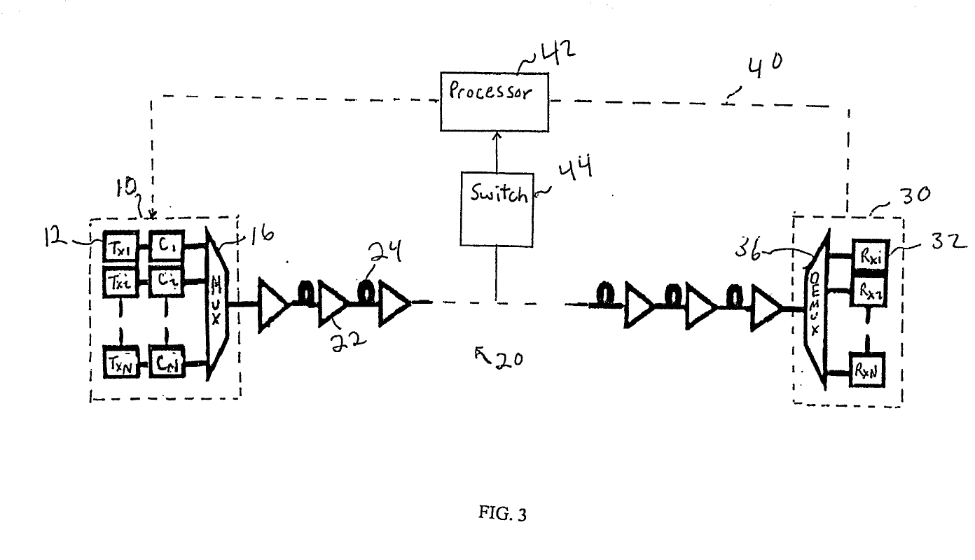

As the system gets longer, e.g. fifteen spans, the implementation of the technique of the present invention can be broken into more than one piece. For example, as shown in FIG. 3, the calculation for optimizing the performance may be performed at the middle of the span. Here, the elements and performance of the optimization are similar to that of FIG. 1, with the addition of a wavelength selective switch 44, e.g., Corning Incorporated's Dynamic Spectral Equalizer, inserted in the middle of the transmission system. This switch 44 provides the ability to operate on each wavelength separately to the processor 42 to perform optimization for the second half of the system. Multiple points of optimization may be also utilized if the ripple is too large to handle in a single optimization. The optimization points may be provided anywhere along the transmission path as desired.

While a feedback configuration has been disclosed above, the optimization of the present invention may also be realized using an estimate of the optical signal to noise ratio at the end point, or any other desired point in the system. This estimate may be determined from the input power Pᵢₙ, the gains of the amplifiers, and the noise in the amplifiers. For a plurality N amplifiers, each having a gain Gᵢ, a loss figure Lᵢ, and a noise figure NFᵢ associated therewith, the OSNR at a give point “b” of interest is given by:

$${OSNR}_{b} = \frac{{P}_{in} {G}_{1} {L}_{1} {G}_{2} {L}_{2} {…G}_{N} {L}_{N}}{\begin{matrix}{hvB}_{o} [ ( {NF}_{1} {G}_{1} - 1 ) {L}_{1} {G}_{2} {L}_{2} {G}_{3 } … {L}_{N - 1} {G}_{N} + \\ ( {NF}_{2} {G}_{2} - 1 ) {L}_{2} {G}_{3} {L}_{3} {G}_{4} … {L}_{N - 1} {G}_{N} + ( {NF}_{N} {G}_{N} - 1 ) ]\end{matrix}} \qquad ( 4 )$$

where h is Planck's constant, v is the wavelength, and Bo is the bandwidth over which the noise is measured. The optical spectrum is typically divided into bins of Bo and is commonly 12.5 GHz. For a simple case, assume:

GᵢLᵢ=1 (i.e., amplifier gain G_{I} fully compensates proceeding fiber span loss L_{I});

G₁=G₂=G₃=. . . =G_{N}=G;

NF₁=NF₂=NF₃=. . . =NF_{N}=NF; and

Gᵢ>>1

Then equation (4) can be rewritten as:

$${OSNR}_{B} = \frac{{P}_{in}}{{NhvB}_{o} NFG} \qquad ( 5 )$$

In Equation (5), hvNFG is the spontaneous noise density of each amplifier. Since the noise figure NF and the gain G characterize the amplifier, by knowing these two values and the number of amplifiers N in the system or portion thereof being optimized, the correction can be estimated analytically.

The reduction in power required to equalize the expected OSNR may then be reduced as set forth above, e.g., by multiplying by 0.5, to optimize a fiber non-linearity system. This optimization may be hardwired in the transmitter, or may be altered by a user based on any changes in the system using the processor 42, which no longer needs to be connected to the receiver, to alter the control of the transmitters. While this technique does not allow dynamic feedback, it no longer requires detected signals and may be easily adjusted.

While the present invention is described herein with reference to illustrative embodiments for particular applications, it should be understood that the present invention is not limited thereto. Those having ordinary skill in the art and access to the teachings provided herein will recognize additional modifications, applications, and embodiments within the scope thereof and additional fields in which the invention would be of significant utility without undue experimentation.

What is claimed is:

1. An optimizer for a transmission system between a transmission terminal and a reception terminal having at least two channels, the optimizer comprising:
a processor which determines an adjustment for equalizing a predetermined characteristic for each channel and reduces the adjustment by a predetermined amount; and
a plurality of controllers, each controller associated with a transmitter in the transmission terminal, wherein each controller receives the reduced adjustment for an associated channel and provides the reduced adjustment to an associated transmitter.

2. The optimizer of claim 1, wherein the predetermined amount is determined in accordance with a profile of the quality of the signal.

3. The optimizer of claim 1, wherein the predetermined amount is 0.5.

4. The optimizer of claim 1, wherein the predetermined amount is obtained in accordance with a relative influence of noise and fiber non-linearities in the system.

5. The optimizer of claim 1, wherein the predetermined characteristic is optical power.

6. The optimizer of claim 1, wherein the predetermined characteristic is optical signal to noise ratio.

7. The optimizer of claim 1, further comprising a wavelength selective switch at at least one location in the transmission system, said wavelength selective switch allowing each channel to be processed by said processor.

8. The optimizer of claim 7, wherein said at least one location is a plurality of locations in the transmission path.

9. The optimizer of claim 7, wherein said at least one location includes a location intermediate to the transmission system.

10. The optimizer of claim 1, wherein said processor receives measured signals of the predetermined characteristic and determines the adjustment in accordance with the measured signals.

11. The optimizer of claim 1, wherein said processor calculates the predetermined characteristic in accordance with physical parameters of the transmission system.

12. The optimizer of claim 1, wherein the controllers are provided at an output of an associated transmitter.

13. The optimizer of claim 1, wherein the controllers are integral with associated transmitters.

14. An optimizer for a transmission system between a transmission terminal and a reception terminal having at least two channels, the optimizer comprising:
a processor determining an adjustment in accordance with fiber non-linearities of the system; and
a plurality of controllers, each controller associated with a transmitter in the transmission terminal, each controller receiving the adjustment for an associated channel and providing the adjustment to an associated transmitter.

15. The optimizer of claim 14, wherein the adjustment is determined in accordance with both the fiber non-linearities of the system and noise.

16. The optimizer of claim 14, wherein the adjustment is determined in accordance with a profile of the quality of the signal.

17. The optimizer of claim 14, wherein the adjustment is determined in accordance with a relative influence of noise and fiber non-linearities in the system.

18. The optimizer of claim 14, wherein said processor receives measured signals of the predetermined characteristic and determines the adjustment in accordance with the measured signals.

19. The optimizer of claim 14, wherein said processor calculates the predetermined characteristic in accordance with physical parameters of the transmission system.

20. A method of optimizing performance of a transmission system between a transmission terminal and a reception terminal having at least two channels, the method comprising:
determining an adjustment for equalizing a predetermined characteristic for each channel;
reducing the adjustment by a predetermined amount; and
controlling an output of each transmitter in the transmission terminal in accordance with the reduced adjustment for an associated channel.

21. The method of claim 20, wherein said determining the predetermined amount includes analyzing a profile of the quality of the signal.

22. The method of claim 20, wherein the predetermined amount is 0.5.

23. The method of claim 20, wherein said determining includes analyzing a relative influence of noise and fiber non-linearities in the system.

24. The method of claim 20, wherein the predetermined characteristic is optical power.

25. The method of claim 20, wherein the predetermined characteristic is optical signal to noise ratio.

26. The method of claim 20, wherein said determining includes receiving measured signals of the predetermined characteristic.

27. The method of claim 26, wherein said receiving is from at least one of the reception terminal and a non-terminal point in the transmission system.

28. The method of claim 20, wherein said determining includes calculating the predetermined characteristic in accordance with physical parameters of the transmission system.

29. A method of optimizing for a transmission system between a transmission terminal and a reception terminal having at least two channels, the method comprising:
determining an adjustment in accordance with fiber non-linearities of the system; and
controlling an output of each transmitter in the transmission terminal in accordance with the adjustment for an associated channel.

30. The method of claim 29, wherein said determining is in accordance with both the fiber non-linearities of the system and noise.

31. The method of claim 29, wherein said determining is in accordance with a profile of the quality of the signal.

32. The method of claim 29, wherein said determining is in accordance with a relative influence of noise and fiber non-linearities in the system.

33. The method of claim 29, wherein said determining includes receiving measured signals of the predetermined characteristic.

34. The method of claim 33, wherein said receiving is from at least one of the reception terminal and a non-terminal point in the transmission system.

35. The method of claim 29, wherein said determining includes calculating the predetermined characteristic in accordance with physical parameters of the transmission system.
